(19) United States
(12) Patent Application Publication
(10) Pub. No.: US 2018/0154754 A1
(43) Pub. Date: Jun. 7, 2018

(54) APPARATUS FOR SUPPORTING A BATTERY

(71) Applicant: Jaguar Land Rover Limited, Coventry, Warwickshire (GB)

(72) Inventors: Mark ROWLEY, Coventry, Warwickshire (GB); Stephen NICHOLLS, Coventry, Warwickshire (GB); Mark WHITE, Coventry, Warwickshire (GB)

(21) Appl. No.: 15/570,564

(22) PCT Filed: Aug. 11, 2016
(86) PCT No.: PCT/EP2016/069112

§ 371 Date: Oct. 30, 2017

(30) Foreign Application Priority Data
Aug. 11, 2015 (GB) 1514181.5

(51) Int. Cl. B60K 1/04; H01M 2/10; H01M 10/613; H01M 10/625; H01M 10/6556

(52) U.S. Cl. CPC B60K 1/04; H01M 2/1077; B60K 2001/005; H01M 10/625; H01M 10/6556; H01M 10/613

(57) ABSTRACT

An apparatus for supporting a battery in a vehicle wherein the apparatus (3) comprises: a floor section (5) comprising a plurality of internal coolant channels for receiving coolant; and at least one side member (7) comprising at least one internal supply channel for supplying coolant to the internal channels of the floor section.

### TECHNICAL FIELD

The present disclosure relates to an apparatus for supporting a battery in a vehicle and particularly, but not exclusively to an apparatus for supporting a battery in an electric vehicle. Aspects of the invention relate to an apparatus and to a vehicle.

### BACKGROUND

Conventional apparatus for supporting batteries in electric vehicles can be complex and may contribute very little towards the structural body stiffness of the vehicle. They also require cooling modules to be positioned between the apparatus and the battery to enable cooling of the battery. This increases the number and complexity of the components.

It is an aim of the present invention to address at least some of the disadvantages associated with the prior art.

### SUMMARY OF THE INVENTION

Aspects and embodiments of the invention provide an apparatus and vehicle as set out in the appended claims.

According to an aspect of the invention, there is provided an apparatus for supporting a battery in a vehicle wherein the apparatus comprises: a floor section comprising a plurality of internal coolant channels for receiving coolant; and at least one side member comprising at least one internal supply channel for supplying coolant to the internal coolant channels of the floor section. This provides an apparatus which both supports and enables cooling of the battery. This, advantageously, reduces the number of components required within an electric vehicle. The apparatus also advantageously provides improved structural rigidity to the vehicle.

The floor sections may comprise a plurality of floor members connected together. This modular design advantageously enables different floor members having different cross sections to be connected together, as required, to form the floor section. This enables the floor section to be formed from different types of members. In addition, this facilitates the replacement of different ones of the plurality of floor members for maintenance purposes.

The plurality of members may comprise at least one member comprising at least one of the plurality of internal coolant channels and at least one structural support member. This enables the floor section to provide sufficient structural support to bear the load of the battery, while also providing for more efficient heat transfer between the floor section and the battery. Additionally, the structural rigidity of the vehicle is improved.

At least one of the plurality of internal coolant channels may have a different dimension to one or more other internal coolant channels. This allows for improved coolant flow throughout the floor section. The dimensions of the internal coolant channels may be arranged to control the rate of flow of the coolant through the internal coolant channels, to allow for more efficient heat transfer.

In certain embodiments, a plurality of internal coolant channels have a different dimension to one or more other internal coolant channels.

The internal coolant channels having different dimensions may be provided at different positions within the floor section. This enables the floor section to be arranged for optimum heat transfer, and allows for more coolant and/or faster flow rate of coolant to the parts of the battery, which require the most cooling.

In some embodiments the plurality of internal coolant channels having a different dimension may be selectively provided at different positions within the floor section. In this way, the internal coolant channels may be selectively arranged within the floor section in order to achieve the required heat transfer. For example, the internal coolant channels may be arranged to maximise the flow rate of coolant to a specific part of the battery, for cooling purposes.

At least one restrictor is provided within the at least one internal supply channel. This enables the flow of coolant within the internal supply channel to be controlled.

The at least one restrictor may be configured to control flow of coolant to at least one of the plurality of internal coolant channels. This enables the flow of coolant within the floor section to be controlled. This enables different amounts of coolant to be provided to different sections of a battery, as required to achieve the desired cooling.

In certain embodiments, the apparatus may be configured to provide a higher flow of coolant to the centre of a battery. This helps to ensure that all parts of the battery are maintained at optimum operating temperatures.

The apparatus may be made of aluminium. This provides a strong and lightweight support structure, which also provides for improved heat transfer between the coolant and the battery.

At least part of the floor section may be formed by extrusion. This enables the internal coolant channels to be formed internally of the members of the floor section.

The floor section may comprise an underside, and the apparatus may comprise a plurality of protruding members protruding from the underside of the floor section. This increases the structural rigidity of the apparatus.

The apparatus may comprise a protective plate coupled to at least one of the plurality of protruding members. The protective plate protects the underside of the floor section, which in turn protects the underside of the apparatus.

The at least one side member may extend around an edge of the floor section. This enables the coolant to be provided to different members comprised within the floor section. For example, this enables the coolant to be provided to different internal coolant channels comprised within the floor section. Similarly, where the floor section comprises a plurality of floor members, the coolant may advantageously be provided to different floor members.

The apparatus may comprise one or more transverse members configured to extend across the floor section. This increases the structural rigidity of the apparatus.

The apparatus may comprise a seal configured between the at least one internal supply channel and at least one of the plurality of internal coolant channels. This helps to prevent leakage of coolant, and helps to ensure that no coolant comes into contact with the battery.

According to another aspect of the invention, there is provided a vehicle comprising an apparatus as described in the preceding paragraphs.

According to a further aspect of the invention there is provided an apparatus configured to support and provide cooling for a battery in a vehicle.

According to another aspect of the invention, there is provided an apparatus for supporting a battery in a vehicle, wherein the apparatus comprises: a floor section comprising means for receiving coolant; and at least one side member comprising means for supplying coolant to the means for receiving coolant comprised in the floor section.

According to still another aspect of the invention, there is provided an apparatus for supporting a battery in a vehicle, wherein the apparatus comprises: a floor section comprising one or more extruded members, wherein at least one of the extruded members comprises one or more internal coolant channels for receiving coolant; and at least one side member comprising at least one internal supply channel for supplying coolant to the one or more internal coolant channels.

According to a further aspect of the invention there is provided an apparatus configured to support and provide cooling for a battery in a vehicle, and to improve the structural rigidity of the vehicle.

According to a still further aspect of the invention, there is provided an apparatus for supporting a battery in a vehicle wherein the apparatus comprises: a floor section comprising a plurality of internal coolant channels for receiving coolant, wherein the floor section comprises a plurality of floor members connected together comprising at least one member comprising at least one of the plurality of internal coolant channels, and at least one structural support member.

According to another aspect of the invention, there is provided an apparatus configured to support and provide cooling for a battery in a vehicle, wherein the cooling for the battery can be controlled.

According to still another aspect of the invention, there is provided an apparatus for supporting a battery in a vehicle wherein the apparatus comprises: a floor section comprising a plurality of internal coolant channels for receiving coolant, wherein the internal coolant channels are arranged to allow for more coolant and/or faster flow rate of coolant to the parts of the battery which require the most cooling.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a perspective illustration of a vehicle comprising an apparatus for supporting a battery, in accordance with embodiments of the invention;

FIG. 2 is a perspective view of the apparatus comprised in the vehicle of FIG. 1, in accordance with an embodiment of the invention;

FIG. 3 is an exploded perspective view of an apparatus comprised in the vehicle of FIG. 1, in accordance with an alternative embodiment of the invention;

FIG. 4 is a perspective cross-sectional view of a part of the apparatus of either FIG. 2 or 3;

FIG. 5 is a cross-sectional side view of the apparatus of either FIG. 2 or 3, the cross-section being taken in a direction parallel to the length of the apparatus, and comprising a battery;

FIG. 6 is a cross-sectional perspective view of a portion of the apparatus of either FIG. 2 or 3, the cross-section being taken in a direction parallel to the width of the apparatus, the portion comprising a length of a coolant member and a part of a side member, in accordance with an embodiment of the invention;

FIG. 7 is a cross-sectional perspective view of a portion of the apparatus of either FIG. 2 or 3, the portion comprising a length of a coolant member and a part of a side member, in accordance with an alternative embodiment of the invention;

FIG. 8 is a cross-sectional perspective view of a portion of the apparatus of either FIG. 2 or 3, the portion comprising a length of a coolant member and a part of a side member, in accordance with an alternative embodiment of the invention;

FIG. 9 is a perspective view of an end section of the apparatus of either FIG. 2 or 3, in accordance with an embodiment of the invention;

FIG. 10 is a perspective view of an end section of the apparatus of either FIG. 2 or 3, in accordance with an alternative embodiment of the invention; and

FIG. 11 is a perspective view of an end section of the apparatus of either FIG. 2 or 3, in accordance with an alternative embodiment of the invention.

### DETAILED DESCRIPTION

Examples of the present disclosure relate to an apparatus which may be configured to support a battery within a vehicle. For instance, some examples relate to an apparatus which may be used to support a battery in a vehicle such as an electric vehicle (EV) or a hybrid electric vehicle (HEV).

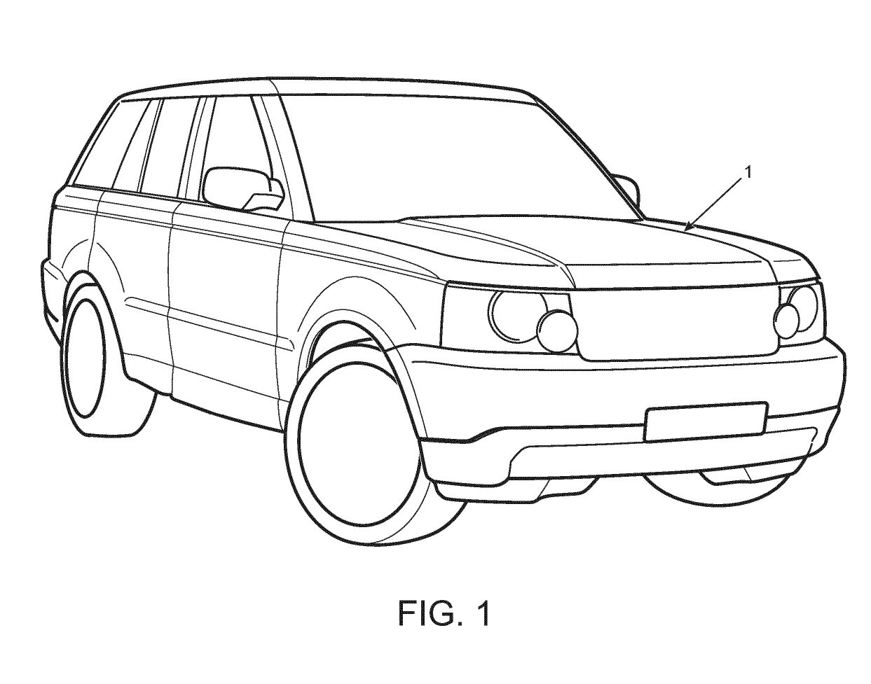

FIG. 1 illustrates a vehicle 1, which may comprise apparatus according to embodiments of the present invention. It is to be appreciated that the vehicle 1 of FIG. 1 is provided as an illustrative, non-limiting example of the types of vehicle that the apparatus of the present invention may be used in combination with. It is to be appreciated that the apparatus of the present invention may be used in combination with any EV or HEV.

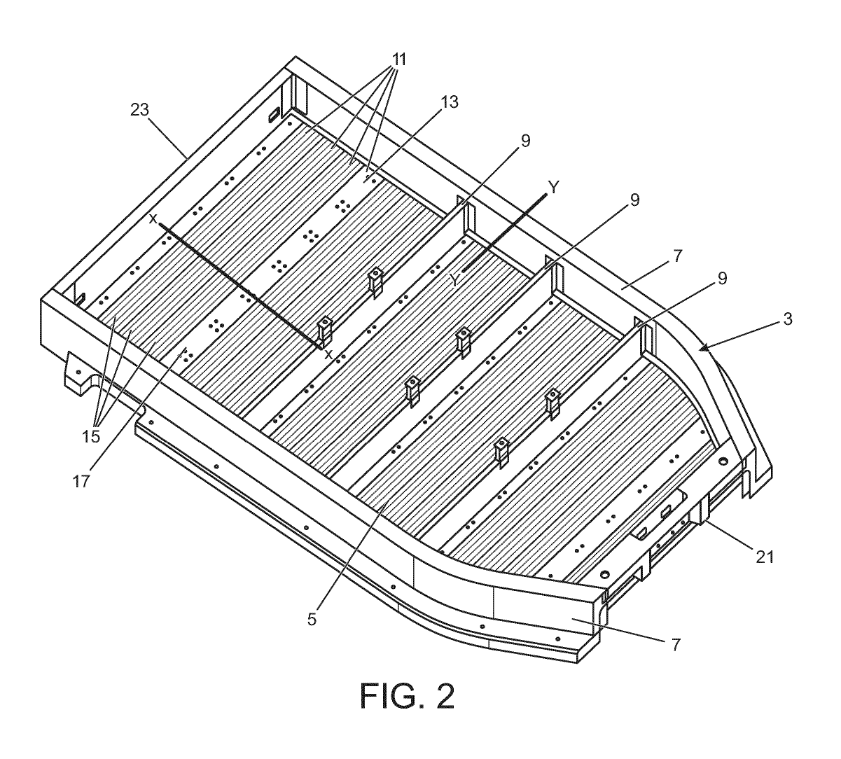

FIGS. 2 to 11 illustrate an apparatus 3 or portions of the apparatus 3 for supporting a battery in a vehicle 1. The apparatus 3 comprises: a floor section 5 comprising a plurality of internal coolant channels 41 for receiving coolant; and at least one side member 7 comprising at least one internal supply channel 63 for supplying coolant to the internal coolant channels of the floor section 5.

FIG. 2 is a perspective view of an apparatus 3 in accordance with embodiments of the invention. The apparatus 3 comprises a floor section 5 and side members 7. The apparatus 3 of FIG. 2 also comprises a plurality of transverse members 9.

The floor section 5 may be configured to support the weight of a battery 51. The floor section 5 provides a surface 13 upon which a battery 51 and/or modules of a battery 51 may be positioned.

In certain embodiments, the floor section 5 may comprise a plurality of floor members 11, which are connected together to form the floor section 5. The plurality of floor members 11 may be connected together by any suitable means. For example, the plurality of members 11 may be bolted together.

At least some of the floor members 11 may be coolant members 15. The coolant members 15 may comprise internal coolant channels 41. The coolant members 15 enable heat transfer between the floor section 5 and a battery 51 supported by the floor section 5. The internal coolant channels 41 are provided internally of the coolant members 15 of the floor section 5, so that the internal coolant channels 41 are entirely contained within the coolant members 15 of the floor section 5. The internal coolant channels 41 are not visible in FIG. 2.

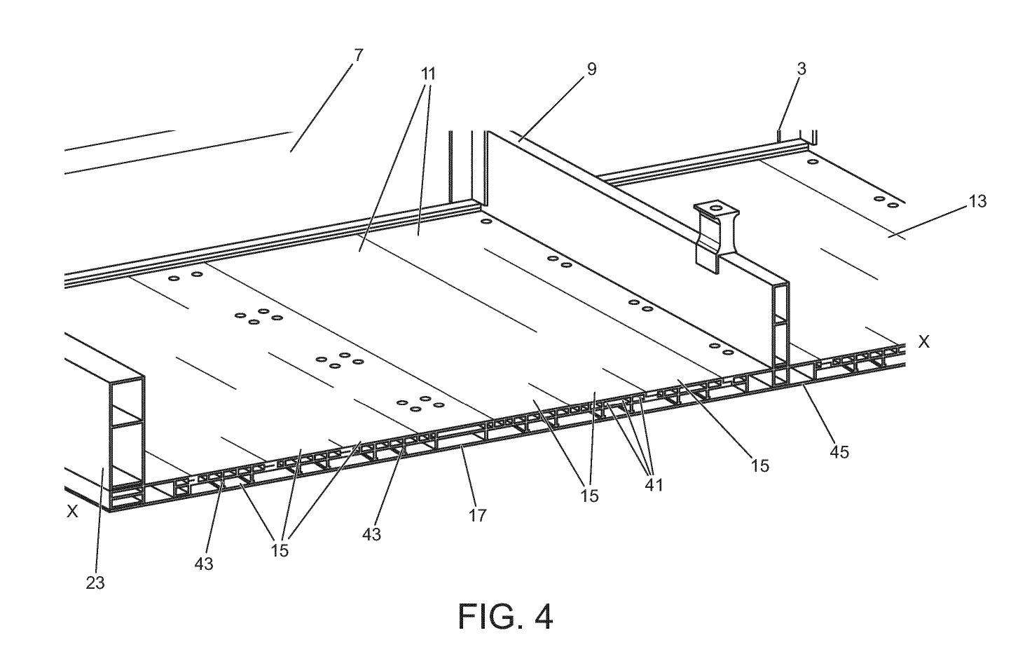

Instead, the internal coolant channels 41, in accordance with embodiments of the invention, are illustrated in FIGS. 4 to 8 and described in further detail below.

At least some of the floor members 11 may be structural support members 17, which may be configured to bear the weight of the battery 51, and/or provide structural rigidity to the apparatus 3. The structural support members 17 may enable a battery 51 to be fixed into position within the apparatus 3.

In some embodiments, the surface 13 of the floor section 5 may be shaped so as to increase the available surface area of the floor section. For example, the surface 13 of the floor section may comprise features such as ridges, grooves, corrugations or any other suitable surface features which increase the available surface area. Such features may be provided on the surface of the coolant members 15. The increased surface improves heat transfer between the floor section 5 and the battery 51.

The apparatus 3 also comprises side members 7. The side members 7 may extend around the edge of the floor section 5, in some embodiments. For example, in FIG. 2, two side members 7 are provided. The side members 7 are provided along respectively opposite edges of the floor section 5. In the embodiment illustrated in FIG. 2, the floor section comprises a substantially rectangular shape bounded by the two side members 7 and two end members, respectively referred to as a first end member 21 and a second end member 23. The side members 7 are slightly tapered at the ends abutting the first end member 21, such that the first end member 21 is shorter in length than the second end member 23.

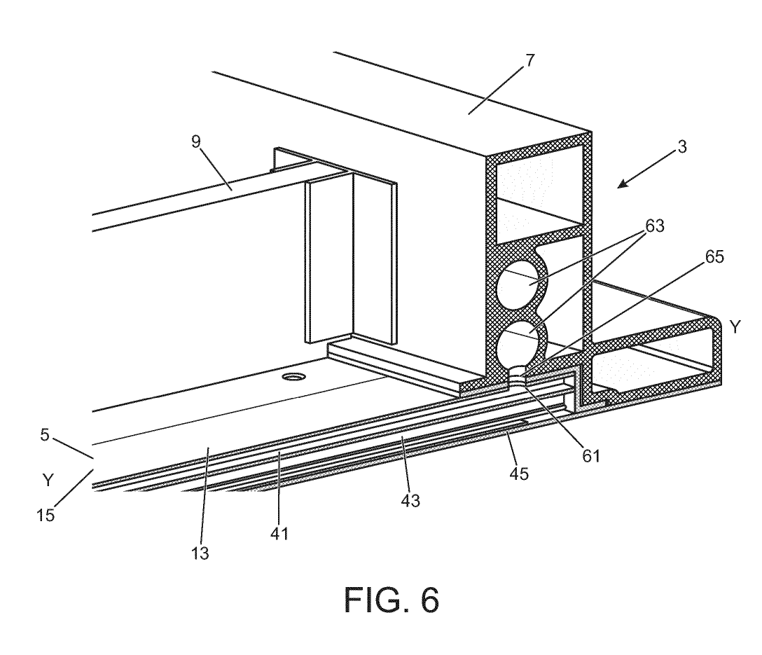

The side members 7 comprise internal supply channels 63 for supplying coolant to the internal coolant channels 41 of the floor section 5. The internal supply channels 63 are provided internally of the side members 7 so that the internal supply channels 63 are entirely contained within the side member 7. The internal supply channels 63 are not visible in FIG. 2, however non-limiting examples of internal supply channels 63 are illustrated in FIGS. 6 to 11 and described in further detail below.

The apparatus 3 also comprises a plurality of transverse members 9. The transverse members 9 extend across the floor section 5 between the two side members 7. The transverse members 9 may be arranged so that they can be positioned between modules of a battery 51. The transverse members 9 may be positioned in alignment with the structural support members 17 of the floor section. The transverse members 9 provide for increased structural rigidity of the apparatus 3.

The transverse members 9 may be arranged to be positioned between modules of the battery 51. In the prior art apparatus, the space between the battery modules is often filled with coolant pipes. However, in embodiments of the present invention, the coolant is provided internally to the apparatus 3 so that transverse members 9 can be provided in place of the coolant pipes. The use of transverse members 9 provides a stronger and more rigid apparatus 3.

The first end member 21 is provided at a front end of the apparatus 3 and the second end member 23 is provided at the rear end of the apparatus 3. The end members 21, 23 may be arranged to connect the side members 7 to form a rigid frame around the floor section 5, as illustrated in FIG. 2. The end members 21, 23, side members 7 and floor section 5 define a cavity within which a battery 51 and/or modules of a battery 51 may be positioned.

The apparatus 3 may be formed from a strong and lightweight material. The floor section 5 may be formed from a material, which is a good thermal conductor to allow for efficient heat transfer between the coolant within the floor section 5 and the battery 51 positioned above the floor section 5. In some embodiments, the apparatus 3 may be formed from a material such as aluminium.

In some embodiments, parts of the apparatus 3 may be formed by extrusion. Extrusion enables parts, such as the floor members 11 and/or the side members 7, to be formed having any suitable and/or desired cross section. This enables, for example, the internal coolant channels 41 and the internal supply channels 63 to be formed internally to the parts of the apparatus 3. This also enables the internal coolant channels 41 and the internal supply channels 63 to be formed having any suitable and/or desirable size and/or shape. This form of manufacture also enables different sized internal coolant channels 41 to be provided in different parts of the floor section 5. The use of extrusion processes to form the parts of the apparatus 3 also enables design features to be provided on the surface 13 of the floor section 5.

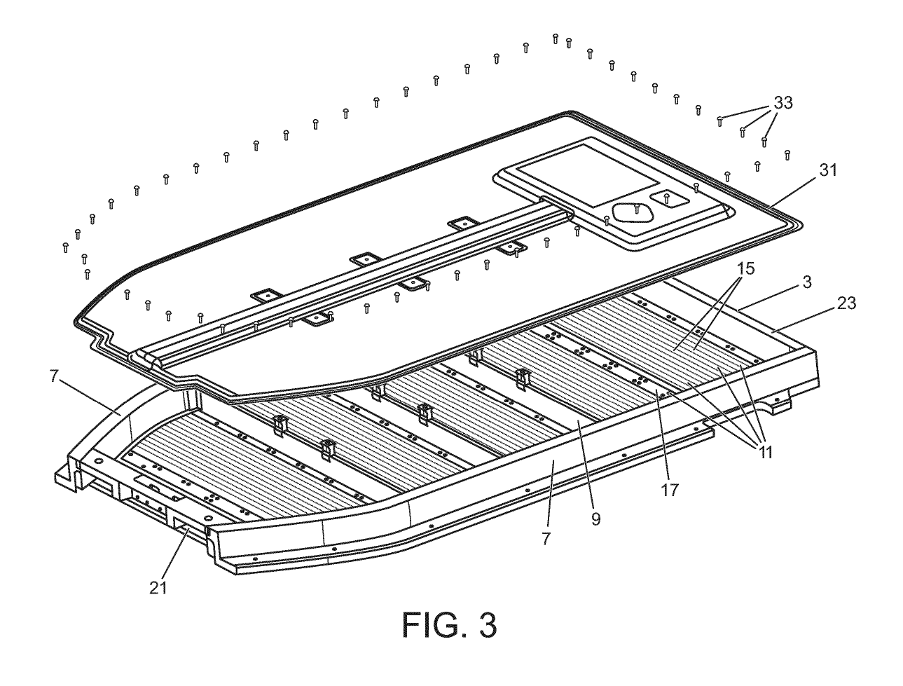

FIG. 3 is an exploded perspective view of an apparatus 3, in accordance with alternative embodiments of the invention. The illustrated apparatus 3 shares several features in common with the apparatus of FIG. 2, and accordingly corresponding reference numerals are used for corresponding features shared with the apparatus of FIG. 2. In the embodiment illustrated in FIG. 3, the apparatus 3 comprises a cover 31. The cover 31 may be configured to be attached to the apparatus 3 to provide a casing for a battery 51.

The cover 31 may be arranged to be attached to the side members 7, by any suitable means. In the illustrated embodiment of FIG. 3 the cover is attached by a plurality of screws 33, which are configured to secure the cover 31 to the side members 7 and to the end members 21, 23. It is envisaged that in alternative embodiments other means for attaching the cover to the side members 7 and/or end members 21, 23 may be used, and such alternatives fall within the scope of the present invention.

FIG. 4 is a cross section view of a part of the apparatus 3, the cross section being taken through the line X-X indicated in FIG. 2, in accordance with an embodiment.

FIG. 4 shows the internal cross section of a plurality of floor members 11 comprised in the floor section 5. The plurality of floor members 11 comprise both coolant members 15 and structural support members 17.

The coolant members 15 comprise a plurality of internal coolant channels 41. Only some of the internal coolant channels 41 have been labeled in FIG. 4 for clarity.

The internal coolant channels 41 may comprise a cavity, which is wholly contained within a floor member 11, and which provides a path for the coolant. The cavity may be of any desired shape. The internal coolant channels 41 may be provided underneath the surface 13 of the floor section 5. In FIG. 4, each one of the coolant members 15 comprises a plurality of internal coolant channels 41. Specifically, each one of the coolant members 15 comprises five internal coolant channels 41. It is to be appreciated however, that in alternative embodiments the coolant members 15 may comprise one or more internal coolant channels 41.

In the embodiment illustrated in FIG. 4, each one of the internal coolant channels 41 has a rectangular-shaped cross section. Alternatively shaped cross-sections are also envisaged, and fall within the scope of the present invention. For instance, in certain embodiments the internal coolant channels 41 could have circular or elliptical shaped cross sections.

In the embodiment illustrated in FIG. 4 the internal coolant channels 41 are uniformly distributed across a length of the floor section 5, such that each coolant member 15 has the same cross section shape and the same number and size of internal coolant channels 41. In alternative embodiments the size and/or shape and/or number of internal coolant channels 41 may be non-uniform across the length of the floor section 5. Both arrangements, advantageously enable the flow of coolant to be controlled.

It is envisaged that any suitable means could be used to control the flow of coolant within the internal coolant channels 41. For example, in certain embodiments one or more restrictors may be positioned within the internal coolant channels 41, and/or the profiles of the internal coolant channels 41 may vary along their length.

In certain embodiments the internal coolant channels 41 may be designed so as to optimize the heat transfer between the coolant and the battery 51. For example, the internal coolant channels 41 may be arranged to ensure that coolant flows efficiently to all parts of the floor section 5. In certain embodiments the internal coolant channels 41 may be arranged to increase the coolant flow to the parts of floor section 5, which lie underneath the parts of the battery 51 which require the most cooling.

The coolant members 15 may also comprise a plurality of protruding members 43. The protruding members extend perpendicularly from the underside of the floor section 5. The protruding members 43 may extend across the width of the underside of the floor section 5. The protruding members 43 may share a common flange. Each one of the coolant members 15 may comprise a plurality of protruding members 43.

The protruding members 43 may be arranged to increase the structural rigidity of the apparatus 3. The protruding members 43 provide a crushable element which may act to protect the coolant members 15 and the battery 51 in the event that something impacts the underside of the vehicle 1.

In the example of FIG. 4 the protruding members 43 are I-shaped members. It is to be appreciated that other shaped members could be used in other examples. For instance the protruding members 43 could be box-shaped, circular, T-shaped or any other suitable shape.

In the embodiment illustrated in FIG. 4, the protruding members 43 are connected to a protective plate 45. The protruding members 43 may be arranged to space the protective plate 45 from the underside of the internal coolant members 15. There may be a gap provided between the protective plate 45 and the internal coolant members 15.

The protective plate 45 may be arranged to cover the underside of the floor section 5. The protective plate 45 may be arranged to protect the internal coolant channels 41 from damage which could be caused by impacts or contact with other objects.

The structural support members 17 are provided between the coolant members 15. The structural support members 17 may be configured to bear the weight of the battery 51 and/or provide structural rigidity to the apparatus 3. In the embodiment of FIG. 4, a transverse member 9 is positioned over one of the structural support members 17. In this embodiment no internal coolant channels are provided within the structural support members 17. This ensures that the structural support member 17 provides sufficient strength and rigidity.

In certain embodiments the coolant members 15 and structural support members 17 are arranged in an alternating sequence in the floor section 5. In the embodiment illustrated in FIG. 4, the floor section 5 comprises three coolant members 15 provided between single structural support members 17. It is to be appreciated that other arrangements and configurations of the members 11 may be provided in other embodiments. The size and number of floor members 11 comprised within the floor section may depend on the size of the battery 51 that is to be supported. In embodiments where the floor members 11 are formed by extrusion this may limit the width of the floor members, and so may condition the number of required floor members 11 comprised in the floor section 5.

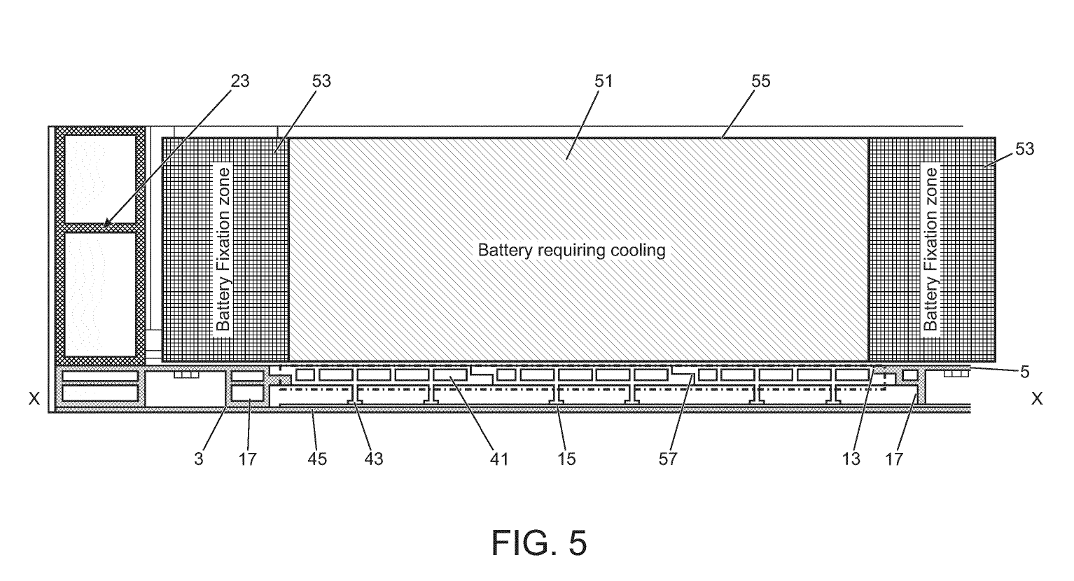

FIG. 5 illustrates another cross section taken through a part of the apparatus 3, specifically taken along the line X-X indicated in FIG. 2. In the embodiment illustrated in FIG. 5, a battery 51 is provided within the apparatus 3.

The battery 51 comprises end portions 53 and a central portion 55. The end portions 53 provide fixation zones which enable the battery 51 to be secured to the apparatus 3. The floor section 5 may be arranged so that the end portions 53 are provided overlaying the structural support members 17 comprised in the floor section 5. The end portions 53 may be arranged so that they can be secured to the structural support members 17.

The floor section 5 may also be arranged so that the central portion 55 of the battery 51, which requires cooling is positioned overlaying the coolant members 15.

The apparatus 3 may be arranged so that the gap between the coolant members 15 and the central portion 55 of the battery 51 is small. In certain embodiments the gap may be minimized so as to enable efficient heat transfer between the central portion 55 of the battery 51 and the coolant within the internal coolant channels 41.

In the embodiment of FIG. 5, the gap present between the central portion 55 of the battery 51 and the surface 13 of the floor section 5 is consistent, such that the spacing between the surface of the floor section 5 and the central portion 55 of the battery 51 is uniform across the length of the floor section 5. This ensures that consistent heat transfer is provided across the surface 13 of the floor section 5. In certain embodiments the consistency of the gap may be obtained by the adopted method of manufacturing of the floor members 11. For example, this may be achieved by using extrusion, or any other suitable manufacturing technique, to form the floor members 11.

In certain embodiments a thin film may be provided in the gap between the surface 13 of the floor section 5 and the central portion 55 of the battery 51. The thin film may comprise a material with a high thermal conductivity to ensure improved heat transfer between the battery 51 and the floor section 5. In some embodiments the thin film may have a high coefficient of friction to prevent the battery 51 from slipping within the apparatus 3.

The embodiment illustrated in FIG. 5 comprises L-shaped edge portions 57 located at the junctions of adjacently located floor members 11. The L-shaped edge portions 57 enable adjacent floor members 11 to be coupled together at their edges. In certain embodiments the L-shaped edge portions may be configured to enable adjacent floor members 11 to be bolted together or secured together using any other suitable fixation means. The L-shaped edge portion 57 may extend along the length of the floor member 11.

FIG. 6 is a perspective view of a cross section of a portion of the apparatus 3, in accordance with an alternative embodiment of the invention. The cross section of FIG. 6 is taken through the line Y-Y shown in FIG. 2. The cross section of FIG. 6 shows a section taken along the length of a coolant member 15, which also comprises a part of a side member 7.

The internal coolant channel 41 extends along the length of the coolant member 15. The internal coolant channel 41 may be configured with a uniform width along the length of the coolant member 15. This ensures consistent flow of the coolant.

An opening 61 is provided within the coolant member 15 providing a channel enabling coolant to be provided from the internal supply channel 63 to the internal coolant channel 41. The opening 61 may be provided at the edge of the coolant member 15. In the illustrated embodiment of FIG. 6 the opening is provided in the upper surface 13 of the coolant member 15. The size and shape of the opening 61 may be designed to control the flow of coolant into the internal coolant channel 41.

The side member 7 comprises an internal supply channel 63. The internal supply channel 63 is configured to provide coolant to the internal coolant channels 41 of the floor section 5 via the opening 61. Two internal supply channels 63 are provided within the side member 7, in the embodiment of FIG. 6. In alternative embodiments, a different number of supply channels 63 may be provided.

The side member 7 is positioned so that the internal supply channel 63 is provided above the end portion of the coolant member 15. In particular, the side member 7 is positioned so that the internal supply channel 63 is provided over the opening 61 in the coolant member 15, such that the internal supply channel 63 and the opening 61 are in fluid communication.

The internal supply channel 63 may comprise an outlet 65. The outlet 65 may be aligned with the opening 61 in the coolant member 15, to enable coolant to flow from the internal supply channel 63 into the coolant member 15.

Whilst only a portion of the internal supply channel 63 is illustrated in FIG. 6, it is to be appreciated that the internal supply channel 63 may extend along the length of the side member 7. The internal supply channel 63 may comprise a plurality of outlets 65. The outlets 65 may be spaced along the length of the internal supply channel 63 to enable coolant to be provided to a plurality of different internal coolant channels 41. The outlets 65 may be formed by machining or any other suitable method of manufacture.

In the embodiment of FIG. 6, two internal supply channels 63 are provided within the side member 7. In alternative embodiments a different number of internal supply channels 63 may be provided. In use, the apparatus 3 may be arranged so that coolant flows through an internal supply channel 63 in a first side member 7, into a coolant member 15 and then flows along the length of the coolant member 15 and out of the coolant member 15 into an internal supply channel 63 configured in the side member 7 located opposite the side member 7 through which the coolant flowed into the coolant member 15. In some embodiments the side members 7 may comprise corresponding internal supply channels 63. In some examples the side members 7 may be arranged as mirror images so that the apparatus 3 is balanced.

In some embodiments a gasket or seal may be provided around the outlet 65 and opening 61 to prevent leakage of the coolant. In other embodiments continuous welding methods may be used to connect the side member 7 to the floor section, the welding providing the function of a seal to minimize coolant leakage.

In some embodiments the apparatus 3 may comprise means for controlling the flow of coolant within the internal supply channels 63. For instance, one or more restrictors may be provided within the internal supply channels 63. The restrictor may be configured to control the flow of coolant from the internal supply channels 63 to the internal coolant channels 41. In some embodiments, the profile of the internal supply channels 63 may vary along its length. The means for controlling the flow of coolant may be configured to enable the coolant to flow equally to all parts of the floor section 5. Alternatively, the means for controlling the flow of coolant may be designed to provide a greater flow of coolant to certain areas of the battery 51. For instance, the flow of coolant may be manipulated to provide a greater flow of coolant to the centre of the battery 51. Similarly, the flow of coolant may be manipulated to direct more coolant to those parts of the apparatus 3 proximal to the parts of the battery requiring the most cooling (e.g. to the hottest parts of the battery).

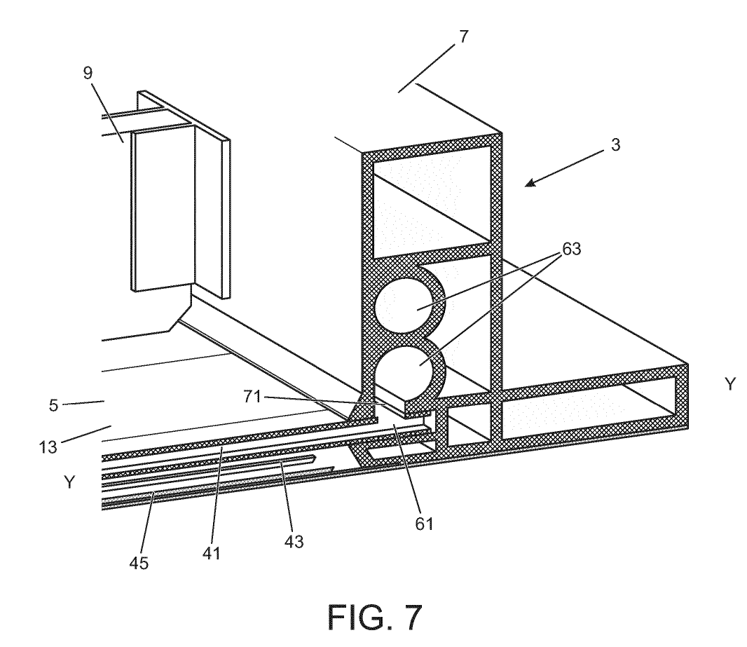

It is to be appreciated that the specific configuration illustrated in the embodiment of FIG. 6 is non-limiting, and different embodiments may comprise different configurations to enable coolant to flow between the internal supply channel 63 and the internal coolant channel 41. For example, FIG. 7 illustrates an embodiment comprising an alternative configuration. In the embodiment of FIG. 7, the internal supply channel 63 comprises an opening 71, which opening is located in a different position relative to the opening illustrated in the embodiment of FIG. 6. In particular, the opening 71 is provided in a side of the internal supply channel 63. The coolant member 15 also comprises an opening 61. The opening 61 comprised in the coolant member 15 may be similar to the one illustrated in FIG. 6. The opening 71 in the internal supply channel 63 may be arranged to be positioned over the opening 61 in the surface of the coolant member 15.

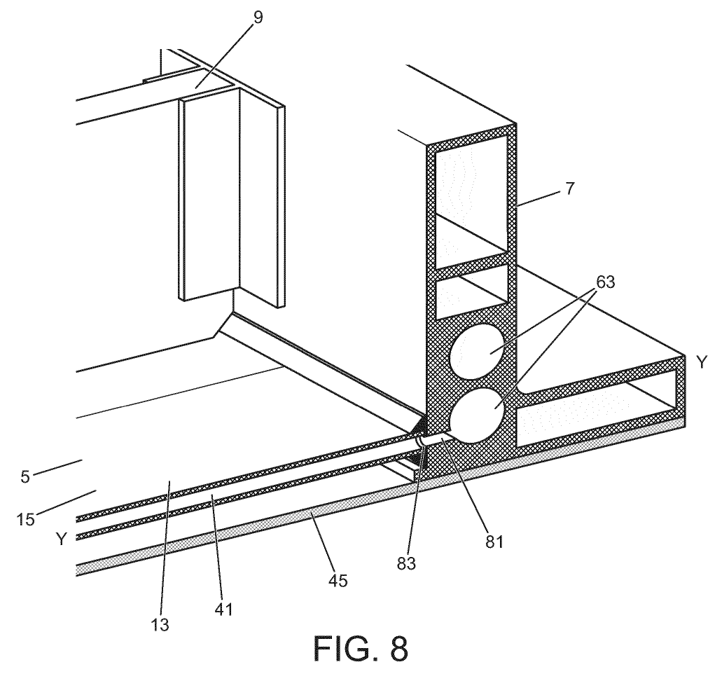

FIG. 8 illustrates a further configuration for connecting an internal supply channel 63 to an internal coolant channel 41, in accordance with an alternative embodiments. There is no opening in the surface 13 of the coolant member 15 in the illustrated embodiment. Instead, the internal supply channel 63 of the side member 7 is positioned adjacent to the end of the internal coolant channel 41. An outlet 81 is provided in a side of the internal supply channel 63 to connect the internal supply channel 63 to the end 83 of the internal coolant channel 41.

It is to be appreciated that the embodiments illustrated in FIGS. 6 to 8 are non-limiting, and that other alternative arrangements may be used to achieve the same desired result, and such alternatives fall within the scope of the present invention.

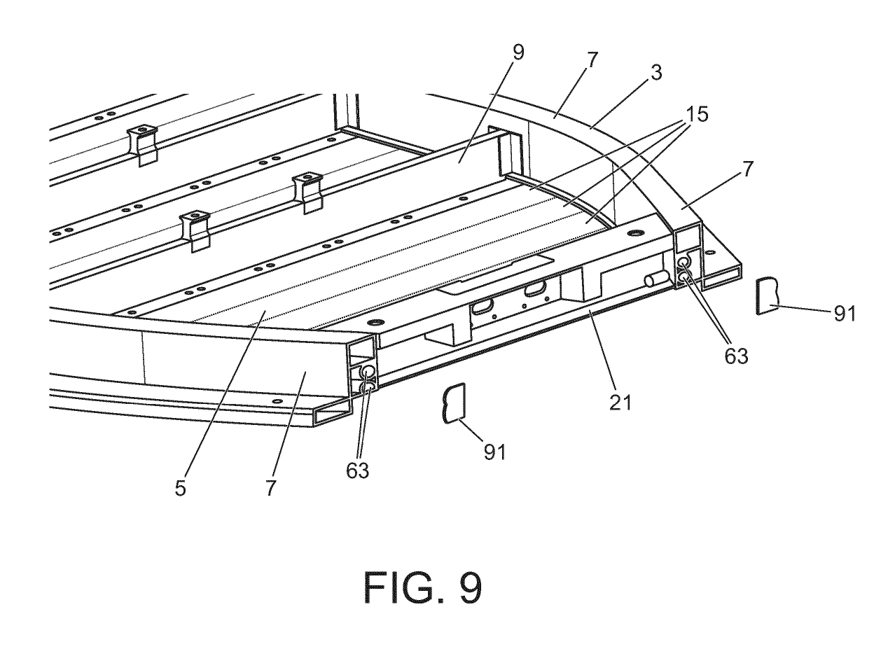

FIG. 9 shows an end section of the apparatus 3, in accordance with an embodiment of the invention. The ends of the internal supply channels 63 may be located in proximity of the end section of the apparatus 3. In the illustrated embodiment, two internal supply channels 63 are provided in each side member 7.

The end section may comprise plugs 91. The plugs 91 may be arranged to cover the ends of the internal supply channels 63. The plugs 91 may be secured to the end of the side members 7 with a sealed joint. The plugs 91 may be sized and shaped to seal the internal supply channels 63.

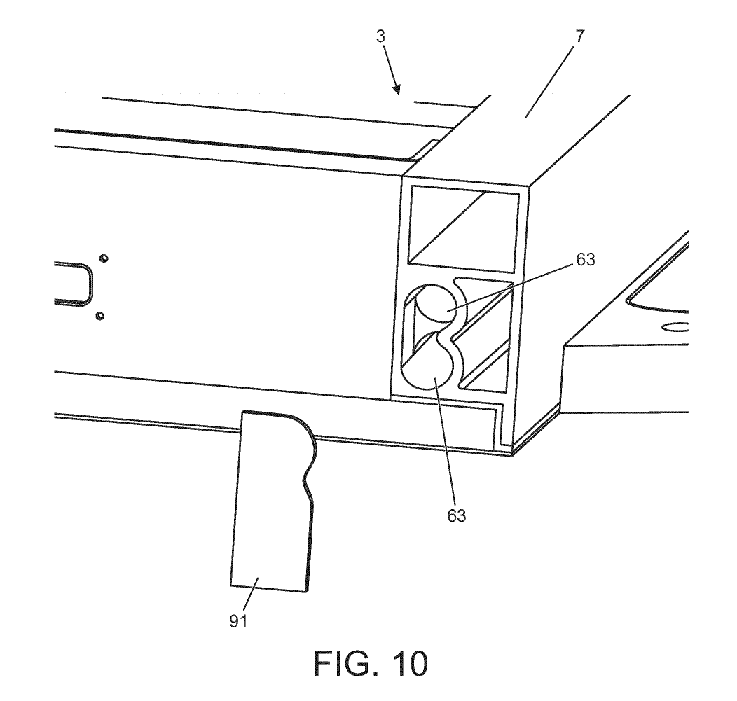

FIG. 10 shows an alternative end section of an apparatus 3, in accordance with an alternative embodiment. The end section may also comprise plugs 91, which are arranged to cover the internal supply channels 63. In FIG. 10 the two internal supply channels 63 within each side member 7 are interlinked. The interlinking between the internal supply channels 63 allows for coolant to flow between the two internal supply channels 63. This may allow the rate of flow to be controlled.

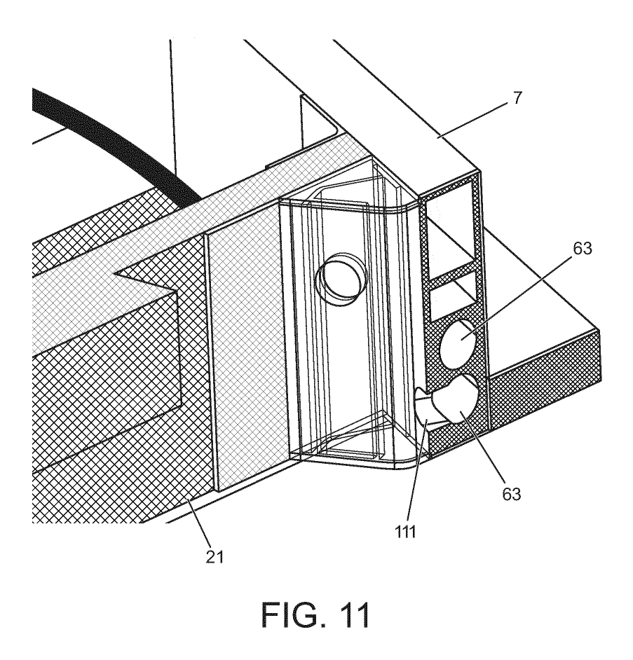

FIG. 11 shows another end section of an apparatus 3, in accordance with yet a further alternative embodiment. In FIG. 11 an inlet 111 is configured in fluid communication with any one of the internal supply channels 63 of the side member 7. The inlet 111 enables coolant to be provided into the internal supply channel 63. It is to be appreciated that a corresponding outlet may be provided for the internal supply channel 63 in the other side member located opposite to the illustrated side member 7.

Embodiments of the present invention provide several advantages. For instance, they enable the cooling mechanism for a battery 51 to be integrated into the support structure for the battery 51. This reduces the number of component parts needed for the support structure of the battery. Since the cooling mechanism may be provided within the support structure this increases the usable space available within the apparatus 3. In some embodiment this space could be used to provide additional structural support, such as the transverse members 9 described above.

Furthermore, as there are no pipes located external to the support apparatus this allows the modules of the battery 51 to be packaged closer together.

As a result of the configuration of the apparatus 3, if a leakage of coolant does occur at the connections between the respective channels 41, 63 the coolant is less likely to interfere with the battery 51 than in conventional apparatus.

Within the context of the present disclosure, where a structural feature has been described, it may be replaced by means for performing one or more of the functions of the structural feature whether that function or those functions are explicitly or implicitly described herein.

The term “comprise” is used in this document with an inclusive not an exclusive meaning. That is, any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this brief description, reference has been made to various embodiments. The description of features or functions in relation to an embodiment indicates that those features or functions are present in that embodiment. The use of the term “embodiment”, “example” or “for example” or “may” in the text denotes, whether explicitly stated or not, that such features or functions are present in at least the described embodiment, whether described as an embodiment or not, and that they can be, but are not necessarily, present in some of or all other embodiments. Thus, “embodiment”, “example”, “for example” or “may” refers to a particular instance in a class of embodiments. A property of the instance can be a property of only that instance or a property of the class or a property of a sub-class of the class that includes some but not all of the instances in the class. It is therefore implicitly disclosed that features described with reference to one embodiment but not with reference to another embodiment, can where possible be used in that other embodiment but does not necessarily have to be used in that other embodiment.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described herein.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus configured to support a battery in a vehicle, wherein the apparatus comprises:
a floor section comprising a plurality of internal coolant channels configured to receive coolant, wherein the internal coolant channels are arranged to allow for more coolant and/or faster flow rate of coolant to parts of the battery which require more cooling; and
at least one side member comprising at least one internal supply channel configured to supply coolant to the internal coolant channels of the floor section.

2. The apparatus as claimed in claim 1, wherein the floor section comprises a plurality of floor members connected together.

3. The apparatus as claimed in claim 2, wherein the plurality of floor members comprises at least one member comprising at least one of the plurality of internal coolant channels and at least one structural support member.

4-5. (canceled)

6. The apparatus as claimed in claim 1, wherein at least one of the plurality of internal coolant channels has a different dimension to one or more other of the internal coolant channels.

7. The apparatus as claimed in claim 1, wherein a plurality of the internal coolant channels have a different dimension to one or more other of the internal coolant channels.

8. The apparatus as claimed in claim 7, wherein the plurality of internal coolant channels having a different dimension are provided at different positions within the floor section.

9. The apparatus as claimed in claim 1, further comprising a first device configured to control flow of coolant within the at least one internal supply channel.

10. The apparatus as claimed in claim 9, wherein the first device comprises at least one restrictor.

11. The apparatus as claimed in claim 9, further comprising a second device configured to control flow of coolant within at least one of the plurality of internal coolant channels.

12. The apparatus as claimed in claim 11, wherein the second device comprises at least one restrictor.

13. The apparatus as claimed in claim 1, further comprising a third device configured to control flow of coolant from the at least one internal supply channel to at least one of the plurality of internal coolant channels.

14. The apparatus as claimed in claim 1, wherein the apparatus is configured to provide a higher flow of coolant to a center of the battery.

15. (canceled)

16. The apparatus as claimed in claim 1, wherein at least part of the floor section is formed by extrusion.

17-18. (canceled)

19. The apparatus as claimed in claim 1, wherein the at least one side member extends around an edge of the floor section.

20. The apparatus as claimed in claim 1, further comprising one or more transverse members configured to extend across the floor section.

21. The apparatus as claimed in claim 1, further comprising a seal configured between the at least one internal supply channel and at least one of the plurality of internal coolant channels.

22. A vehicle comprising the apparatus as claimed in claim 1.

23-24. (canceled)

25. An apparatus configured to support a battery in a vehicle, wherein the apparatus comprises:
a floor section comprising a plurality of internal coolant channels configured to receive coolant, wherein the floor section comprises a plurality of floor members connected together and the plurality of floor members comprises at least one member comprising at least one of the plurality of internal coolant channels and at least one structural support member configured to improve structural rigidity of the vehicle; and
at least one side member comprising at least one internal supply channel configured to supply coolant to the plurality of internal coolant channels.

26. An apparatus configured to support a battery in a vehicle, wherein the apparatus comprises:
a floor section comprising an underside and a plurality of internal coolant channels configured to receive coolant;
a plurality of protruding members protruding from the underside of the floor section; and
at least one side member comprising at least one internal supply channel configured to supply coolant to the internal coolant channels.

27. The apparatus as claimed in claim 26, further comprising a protective plate coupled to at least one of the plurality of protruding members.
